(19) United States
(12) Patent Application Publication
(10) Pub. No.: US 2025/0018882 A1
(43) Pub. Date: Jan. 16, 2025

(54) ACOUSTICALLY ACTIVE COMPONENT FOR A MOTOR VEHICLE, METHOD FOR PRODUCING AN ACOUSTICALLY ACTIVE COMPONENT FOR A MOTOR VEHICLE, AND ADVANTAGEOUS APPLICATIONS OF AN ACOUSTICALLY ACTIVE COMPONENT FOR A MOTOR VEHICLE

(71) Applicant: CARCOUSTICS TECHCONSULT GMBH, Leverkusen (DE)

(72) Inventors: Martin PACKHÄUSER, Burscheid (DE); Detlef WINKLER, Wolfsburg (DE); Miguel SEBASTIA, Catarroja-Valencia (ES)

(21) Appl. No.: 18/578,233

(22) PCT Filed: Jun. 30, 2022
(86) PCT No.: PCT/EP2022/068089

§ 371 Date: Mar. 19, 2024

(30) Foreign Application Priority Data
Jul. 13, 2021 (DE) 10 2021 118 113.5
Dec. 7, 2021 (DE) 10 2021 132 223.5
Jan. 18, 2022 (DE) 10 2022 101 081.3

(51) Int. Cl. B60R 13/08

(52) U.S. Cl. CPC B60R 13/0815; B60R 13/0861

(57) ABSTRACT

An acoustically active component for a motor vehicle, to a method for producing an acoustically active component for a motor vehicle, and to a method for using a component according to the invention in a motor vehicle in an intended manner. The components are particularly suitable for use as acoustically active interior or exterior components.

### CROSS-REFERENCE TO RELATED APPLICATIONS

This application is a 35 U.S.C. § 371 National Stage patent application of PCT/EP2022/068089 filed on 30 Jun. 2022, which claims the benefit of German patent application 10 2021 118 113.5, filed on 13 Jul. 2021, German patent application 10 2021 132 223.5, filed on 7 Dec. 2021, and German patent application 10 2022 101 081.3, filed on 18 Jan. 2022, the disclosures of which are incorporated herein by reference in their entirety.

### TECHNICAL FIELD

The present disclosure relates to an acoustically effective component for a motor vehicle, a method for producing an acoustically effective component for a motor vehicle as well as advantageous uses of an acoustically effective component for a motor vehicle.

### BACKGROUND

A variety of acoustically effective components for motor vehicles are known from the prior art. For example, DE 35 06 004 A1 discloses an acoustically effective filler, which consists of an open-cell 3D-shaped foam body, which is covered with an air-impermeable plastic film. DE 35 06 004 A1 proposes prefabricating corresponding fillers in the compressed state during production such that these fillers can be inserted directly into cavities to be sealed on delivery. Subsequently, the plastic covering of the filler is to be perforated, which results in an expansion of the filler such that the filler seals the cavity and is fixed in it. However, what is disadvantageous about the filler known from DE 35 06 004 A1 is that the production of a three-dimensionally shaped foam block is time-consuming and thus costly using the methods previously known from the prior art.

If more complex shaped fillers are to be produced, correspondingly three-dimensionally shaped foam bodies must be produced, which according to the prior art is preferably done using moulded foams. For this purpose, a reactive mixture of two components is injected into a heated mould, in which the components react with each other to form a foam block, which may also have a complex shape. However, the reaction times of the components must be taken into account here, meaning that in practice the formation of such a foam block requires mould closing times of 120 seconds or more. This results in high cycle times, which increases production costs. The closed cover of the filler, which acts in a sound-reflecting manner, is also acoustically disadvantageous, meaning that the ability of the filling of the filler to absorb sound is substantially reduced.

DE 10 2013 101 151 A1 also discloses an acoustically effective filler for insertion into a cavity, e.g. a vehicle body. The filler comprises a plastic cover and a foam filling material inserted into the plastic cover. The foam filling material comprises foam flakes, which are inserted into the plastic cover as bulk or randomly arranged flakes. In this filler too, the closed cover of the filler, which acts in a sound-reflecting manner, has proven acoustically disadvantageous, meaning that the ability of the filling of the filler to absorb sound is substantially reduced.

The fillers known from EP 0 680 845 A1, which are also provided for use in motor vehicles, are also based on the use of foam flakes. The fillers disclosed there have a cover made of a gas-tight plastic film, which is filled with open-cell or mixed-cell foam flakes, evacuated and subsequently sealed. The evacuated fillers are then inserted into cavities to be acoustically sealed, where the cover is perforated such that the compressed foam flakes can re-expand, resulting in a mechanical hold of the fillers through a tight fit. However, in practice, it has transpired that the acoustic performance of these fillers is limited beyond a pure sealing effect due to the acoustically hard cover.

In this context, the present disclosure proposes an acoustically effective component for a motor vehicle that has improved acoustic properties. Furthermore, the present disclosure proposes an advantageous method for producing an acoustically effective component for a motor vehicle. Finally, the present disclosure proposes an advantageous method for the intended use of an acoustically effective component in a motor vehicle.

This is achieved by providing a component, by production methods and a method for the intended use according to the claims.

It should be noted that the features listed individually in the claims can be combined with each other in any technically feasible way (even across category boundaries, for example between method and device) and show further embodiments of the disclosure. The description additionally characterizes and defines the disclosure, in particular in connection with the figures.

It should also be noted that a conjunction “and/or” used herein between two features and linking them together is always to be interpreted such that in a first embodiment of the subject according to the disclosure only the first feature may be present, in a second embodiment only the second feature may be present and in a third embodiment both the first and the second feature may be present.

An acoustically effective component according to the disclosure is provided for use in a motor vehicle. It has a bag formed from at least one plastic film and which forms a chamber. A filling is arranged in the chamber, wherein the filling has foam particles of open-cell and/or mixed-cell foams.

According to the disclosure, it is provided that the filling has a mixture of foam particles, wherein the mixture comprises a first portion of non-viscoelastic foam, and a second portion of viscoelastic foam.

Each portion can comprise different foams, which are, however, respectively all either non-viscoelastic or viscoelastic.

It surprisingly transpired that an addition of viscoelastic foam particles leads to significantly improved acoustic properties of the components according to the disclosure compared to the generic components previously known from the prior art. This improvement relates both to the sound-insulating properties of the components and the sound-absorbing properties. The sound-absorbing properties can even be better than those of a sound-absorbing body made of open-cell polyurethane foam above a cut-off frequency, which can be in the range of a few 100 Hertz.

Moreover, the addition of foam flakes from a viscoelastic foam slows down the recovery of a compressed component according to the disclosure. Compression is in particular possible when the plastic film is micro-perforated. If a film that is impermeable to media is used, a component according to the disclosure can also be compressed by means of evacuation. Re-expansion occurs when the plastic film is perforated. If, however, the installation position is not easy to access for a perforation tool, the plastic film must be perforated before the component is moved to its installation position.

In both cases, the addition of viscoelastic foam flakes, for example, affords the worker more time to move a compressed component according to the disclosure to its installation position in a motor vehicle, which significantly simplifies the assembly of such a component. This constitutes a substantial practical advantage of a component according to the disclosure.

Suitable foam particles include in particular shredded residues from an open-cell or mixed-cell foam made of PUR (polyurethane) or preferably viscoelastic PUR or mixtures thereof. These foams are available in large quantities as residual materials. For example, they are produced in the manufacture of mattresses. The production of foam-based stamped parts, which are widely used in the automotive industry, also generates relatively large amounts of residual materials that can advantageously be used within the scope of the present disclosure. But it is also advantageously possible to use shredded residues of suitable foams from recycling.

In the case of viscoelastic foams, acrylate-impregnated foams, in particular those made of PUR, have proved particularly successful. These foams can, for example, be impregnated with a preferably aqueous dispersion of a copolymer based on acrylic acid ester. Acrylate-impregnated foams have a high density with a simultaneously low compression hardness, i.e. they can be easily compressed, are viscoelastic and have a low compression set. This means that they return to their original shape almost completely when they are no longer subjected to an external force. Typical bulk densities of such foams are at least 40 kg/m³, they can also be between 80 kg/m³ and 150 kg/m³, which can also be advantageous for certain applications.

Foam particles from low-emission foams are preferred for use of the components according to the disclosure in a vehicle interior.

Furthermore, the term foam particles should also be understood in the scope of the present disclosure to mean single-piece foam blocks that are adapted in their design to the chamber formed in the bag.

In one preferred embodiment of the disclosure, the proportion by weight of the non-viscoelastic first portion is at least 40% and up to 60% of the weight of the filling. In this embodiment, the proportion by weight of the viscoelastic second portion is at least 40% and up to 60% of the weight of the filling.

Within the scope of this preferred embodiment, weight ratios of 50% each for both portions have in particular proven acoustically advantageous.

It has furthermore proven particularly advantageous if the foam of the first portion has an average density of 28-40 kg/m³, preferably of 28-30 kg/m³.

Conversely, it has proven advantageous if the foam of the second portion has an average density of 40-50 kg/m³, preferably of 40-45 kg/m³.

It has proven particularly suitable for this preferred embodiment if the foam for the foam particles of the first and/or second portion comprises PUR or consists of PUR. A polyether foam is particularly preferably used at least for the foam particles of the first portion. However, a polyether foam can also advantageously be used for the foam particles of the second portion.

In one acoustically particularly advantageous embodiment, the second portion of the foam particles comprises for its part two fractions, which differ in their density by at least 25%.

In one particularly preferred embodiment, the first fraction of the viscoelastic portion thus has an average density of 40 kg/m³-50 kg/m³. Conversely, the second fraction in this embodiment has an average density of 70 kg/m³-90 kg m/³.

If the second (viscoelastic) portion of the foam particles comprises for its part two fractions, which differ in their density by at least 25%, it has furthermore proven acoustically particularly advantageous if the proportion by weight of the first fraction is between 80% and 100% and the proportion by weight of the second fraction is between 20% and 0%. The proportion by weight of the first fraction is preferably between 85% and 95% and the proportion by weight of the second fraction is preferably between 5% and 15%. In a very particularly preferred embodiment, the proportion by weight of the first fraction is around 90% and the proportion by weight of the second fraction is around 10%.

It was surprisingly discovered that even the addition of a small proportion by weight of foam flakes from a denser foam as proposed above leads to a significant improvement of the acoustic insulation effect of a component according to the disclosure.

The filling provided according to the disclosure made of open-cell or mixed-cell foam particles has a high acoustic absorption capacity, which can be adapted to the specific intended purpose of the acoustically effective component through targeted material selection and/or material composition.

It should be noted that the density of the filling can be influenced on the one hand by the selection of the material for the filling, but on the other hand also by the amount of filling inserted into the first chamber, i.e. by the compression of the material inserted into the chamber.

Selecting a suitable material for the filling adapted to the specific intended purpose of the component according to the disclosure is within the scope of standard professional expertise, to which reference is made at this point.

The foams specified for the filling can be specifically produced for use within the scope of the present disclosure. However, materials that are left over from other manufacturing processes are advantageously used. In this way, these residual materials can be put to good use and do not have to be disposed of in a costly and environmentally disadvantageous manner. On the one hand, this results in cost savings when procuring the raw materials required to implement the present disclosure. On the other hand, high recycling rates can be achieved with the components and moulded parts according to the disclosure without having to compromise on quality.

In practice, it has proven advantageous if the foam particles have an average size of at least 10 millimetres. Foam particles that have this minimum size can be easily handled in automated production processes. However, in principle, smaller foam particles with an average size of, for example, 5 millimetres or larger foam particles with an average size of 20 millimetres of more can also advantageously be used within the scope of the present disclosure.

In this embodiment, it has furthermore transpired that particularly good acoustic absorption properties can be achieved if the filling has an average density of 24 km/m³±6 kg/m³.

It should be noted that within the scope of the present disclosure, the density of a foam or foam particle is always intended to mean the mass per volume of the foam in its relaxed state, unless another compression state of the foam is explicitly referred to.

Furthermore, it has surprisingly proven advantageous in practice that, when the chamber has a chamber volume, the non-compressed volume of the filling to be inserted into the chamber is around 50%±15% of the chamber volume. In other words, in this advantageous embodiment, the filling in the chamber is in the form of a loose bulk of foam flakes.

Overall, there are advantages with regard to processing the plastic film if the plastic film used can be welded. Both thermal welding and welding means of ultrasound or by means of friction welding can be advantageous. However, in principle, other welding methods known from the prior art can also advantageously be used.

Regardless of the specific design of the plastic film, it has proven particularly advantageous if the plastic film can be thermally welded. This is the case, for instance, if the plastic film has a thermoplastic material or is made of such a material. PE, PP, PET or PES have proven to be particularly suitable thermoplastic materials here.

In addition to the use of a single-layer plastic film, the use of a double film has also proven advantageous, having at least one layer made of a thermoplastic material such as PE, PP, PET or PES.

The plastic film is preferably flame retardant by means of suitable additives known from the prior art.

In terms of both tear resistance and efficient use of material, the use of a plastic film with a thickness of no less than 30 micrometres and no more than 60 micrometres, preferably of around 40 micrometres, has proven particularly suitable. Higher material thicknesses of up to over 100 micrometres are possible and allow an increase in tear resistance.

In one preferred embodiment, a plastic film with the aforementioned properties comprises PE, PP, PET or PES or consists of PE, PP, PET or PES.

It has proven particularly advantageous if the density of the plastic film is between 0.8 and 1.2 g/cm³. A plastic film with a density of around 1.0 g/m³ is preferably used.

In one preferred embodiment, a plastic film with the aforementioned properties comprises PE, PP, PET or PES or consists of PE, PP, PET or PES.

In one embodiment of the disclosure, the plastic film is designed to be impermeable to media.

One particularly preferred embodiment of the disclosure is based on that fact that only films that are impermeable to media are used to produce the bag of the component according to the disclosure. One or more sections of one or different films that are impermeable to media are connected to a bag in a suitable manner, which has at least one access opening, via which the bag can be filled with the filling according to the disclosure. Once the filling has been inserted, the bag is then sealed to form the component according to the disclosure. The film(s) are connected to form the bag or to seal it in such a way that a media-tight connection is also created between the adjacent film areas. In particular, the film areas to be connected can thus lie flat on top of each other and be connected together in a media-tight manner, e.g. by means of linear welding. It has now transpired that the targeted introduction of interruptions in the otherwise media-tight connection of the film(s), e.g. in the linear welding, produces components according to the disclosure with particularly advantageous properties.

If, for example, film sections lying flat on top of each other are connected together in a media-tight manner by means of a linear weld seam, and if interruptions are made in this weld seam at some points, the length of which can typically be between 0.5 and 5 millimetres and is preferably around 2 to 3 millimetres, these interruptions form outflow openings for air which is trapped in the closed bag. A component according to the disclosure, which is formed by such a bag filled with a foam-containing filling, can therefore be compressed through the application of an external force.

If the external force is removed again, air can flow back into the bag via the outflow openings such that the component returns to its original shape due to the restoring effect of its foam-containing filling.

The size and number of outflow openings created through the interruptions in the media-tight connection determine how quickly a filled bag can be compressed through the application of an external force and how quickly it is relaxed again once the external force has been removed. The compression speed is also determined by the external force applied. It is therefore possible in this embodiment to quickly compress such components according to the disclosure by applying a suitable external force, but to design the number and dimensioning of the interruptions in the media-tight connection of the film sections in such a way that the relaxation of the components takes place over a significantly longer period of time than the compression.

A worker can therefore compress such a component, for example, by hand and insert it in its compressed state, for example, into a car body cavity, where it then slowly relaxes to return to its original shape and is fixed in place by force and/or form fit. This completely eliminates the need to evacuate components made of bags that are impermeable to media and filled with foam, which are already known from the prior art, into a compressed state, then to move the components into their installation position and then to perforate the media-tight cover of the component so that it can return to its rest position. This constitutes a substantial advantage of the components according to the present exemplary embodiment.

Another substantial advantage of a component according to this embodiment is that the component can be designed to be substantially at least splash-proof despite the compressibility described above. This requires the interruptions to be suitably dimensioned. The aforementioned dimensions have proven particularly suitable. Particularly good splash protection is also achieved if the interconnected film sections of the bag of the component lie flat on top of one another. In this case, the outflow openings are compressed by water accumulating in the outer space of the component and thus sealed.

This makes it clear that the dimensions of the individual outflow openings or interruptions in the media-tight connection of the film sections are advantageously optimized in such a way that optimum splash water tightness is achieved.

On the other hand, the number of outflow openings or interruptions in the media-tight connection of the film sections on a bag of a component according to this exemplary embodiment is advantageously optimized in such a way that an optimum compressibility of the component for the intended use is achieved.

In one embodiment of the disclosure, the plastic film is designed as a micro-perforated plastic film.

In this embodiment, it preferably has a specific flow resistance between 10 and 1,500 Rayl (in the MKS system). More precisely, the acoustic impedance, also known as specific acoustic impedance, is measured using the Rayl unit. This then results in advantageous acoustic properties of the component according to the disclosure. All values given in Rayl relating to the present disclosure are based on the MKS system.

This embodiment offers particular advantages if the characteristic dimensions of the individual micro-perforations in the micro-perforated plastic film are selected such that although the micro-perforated plastic film has a high degree of permeability for water vapour, it at the same time has a low degree of permeability for liquid water. In this context, it has proven advantageous if the characteristic dimensions of the micro-perforations are smaller than 100 micrometres and preferably not larger than 60 micrometres. A characteristic dimension is understood to be a length that characterizes the typical size of the individual micro-perforations. For example, in the case of substantially round micro-perforations, the diameter is to be considered a characteristic dimension.

Here too, it has proven to be acoustically particularly effective in the medium to higher frequency range of the human hearing spectrum if the specific flow resistance of the micro-perforated plastic film is between 80 and 120 Rayl.

If, conversely, a particularly high acoustic absorption capacity is to be achieved at low frequencies of the human hearing spectrum, a specific flow resistance of 750 Rayl±50 Rayl of the micro-perforated plastic film has proven particularly effective.

The plastic film is preferably pressed, glued or welded to itself to form a bag.

In one advantageous embodiment, the component according to the disclosure has a first and a second plastic film, which together form the bag provided according to the disclosure. This embodiment provides wide range of possible applications described below. It is assumed that the first plastic film is designed as a micro-perforated plastic film.

If the component according to the disclosure is not intended to be used in a humid environment, it can be acoustically advantageous if the second plastic film has a micro-perforated plastic film, which has a specific flow resistance that differs considerably from the specific flow resistance of the first plastic film. In particular, a specific flow resistance of under 50 Rayl can be advantageous as such a plastic film already has a really high degree of impermeability to liquid media.

In particular if the component according to the disclosure is intended to be used in a humid environment, it can be advantageous if the second plastic film has a plastic film impermeable to media or is made of such. Such components can be used in environments that require at least one side of the component to be impermeable to media. Examples include door insulation and wheel arch insulation for motor vehicles.

The use of a plastic film that is impermeable to media as material for the second plastic film can, however, also be advantageous if the acoustically effective component according to the disclosure is to have not only sound-absorbing, but also sound-insulating properties. A second plastic film made from a plastic film that is impermeable to media has a high degree of sound reflectivity, resulting in a good sound insulation capacity of such a component according to the disclosure.

Regardless of the choice of material for the first and second plastic film, the first and second plastic film are preferably pressed, glued or welded to one another.

If only one plastic film is provided, it is advantageously pressed, glued or welded to itself to form a bag.

Welding of the first and possibly second plastic film is particularly preferable as welding has production-related advantages and allows a particularly high degree of media impermeability.

Components according to the disclosure are used as acoustically effective damping elements in a motor vehicle owing to their advantageous acoustic properties. Such a damping element can in particular be an acoustically effective exterior or interior component.

Very particularly preferably, such a damping element is a bonnet insulator, an electric motor casing, a headliner insulator, a longitudinal member filling, a sill filling, an A/B/C pillar filling, a bulkhead insulator, a tunnel absorber, a door insulator or a wheel arch absorber.

A method according to the disclosure is provided for producing an acoustically effective component for use in a motor vehicle, in particular a component according to the disclosure. In its simplest form, it has the following method steps:
a) providing a bag formed from at least one plastic film and which forms a chamber, and
b) providing a filling, which has foam particles of open-cell and/or mixed-cell foams, wherein the filling has a mixture of foam particles, wherein the mixture
   i) comprises a first portion of non-viscoelastic foam, and
   ii) comprises a second portion of viscoelastic foam.
c) inserting the filling into the bag.

The filling is advantageously divided into portions of defined weight before being inserted into the chamber.

The filling is advantageously inserted into the chamber by means of, for example, a gravity-driven filling process, by means of extrusion, by means of blowing or else manually, in particular in portions.

In one advantageous embodiment of the method, the bag is sealed once the filling has been inserted.

In another advantageous embodiment of the method, the bag is evacuated before being sealed. In this way, its volume can be reduced such that the component according to the disclosure can be inserted particularly easily into cavities. Once the evacuated component is in place, the plastic film is perforated, for example, with a pointed object such that the component can re-expand due to the restoring forces of the compressed foam flakes. If the bag is suitably dimensioned or shaped, this results in a kind of tight fit for the expanded component, which is advantageous. This method, which can be used in particular when the plastic film is impermeable to media due to the proposed evacuation of the bag, is also covered by the present disclosure.

But even when the plastic film is micro-perforated, a comparable advantageous method can be used. In this, it is provided that the bag is compressed relative to its rest position, for example through the application of an external force, before being arranged at its intended place of use in the motor vehicle. This force can be applied manually, but it can also be exerted mechanically on the component in its expanded rest position.

Depending on the perforation of the plastic film, the re-expansion of the compressed component takes place with a certain delay within a re-expansion time. In one advantageous embodiment of the method according to the disclosure, it is therefore provided that the compressed component is moved to its installation position in the motor vehicle within a time that is as short as possible compared to the aforementioned re-expansion time and in any case shorter than this.

It surprisingly transpired that the acoustic absorption capacity of a component according to the disclosure increases if the component is reduced by at least 30% relative to its volume in its uncompressed rest position in its installed state in the motor vehicle, preferably by at least 50%. This applies in particular if the volume of the uncompressed filling is smaller than the volume of the chamber of the bag of the component in question. This is in particular the case when it is a component according to the Claims.

A bag can easily be made from a plastic film by extruding a plastic film directly into a tubular shape. Sections from such a tube can be cut to length and sealed on one side, e.g. by means of welding, forming a bag with a chamber. This method is also covered by the present disclosure.

However, it also surprisingly transpired that the use of a micro-perforated plastic film with a certain defined permeability for a gas flow allows the use of an alternative advantageous filling method. It has thus been shown that the filling can be inserted into the chamber by means of an air flow as transport medium. This method has proven particularly time-saving.

Filling the chamber by means of extrusion as well as by means of blowing or by means of a filling process are all particularly suitable for the series production of components according to the disclosure. A tubular cover can thus be formed, for example, from an extended plastic film or by means of extrusion, which is welded at one end to form a bag. This bag is subsequently filled with a preferably loose bulk of a weight-measured quantity of the filling. Finally, the second end of the bag is sealed, preferably welded, such that a closed bag filled with a filling is obtained, which constitutes the component according to the disclosure.

Alternatively, a long tubular cover can be formed from an extended plastic film. This cover is subsequently filled with the desired filling in a quasi-continuous process. Components according to the disclosure can then be separated from the resulting continuous semi-finished product in a subsequent process step. Separation can, for example, be carried out in a punching process.

With this method, the chamber is advantageously closed when the components are separated by connecting the opposing cover layers, e.g. by welding.

Finally, the present disclosure also provides an advantageous use of a component or moulded part according to the disclosure. It has been shown that both a component according to the disclosure and a moulded part according to the disclosure can advantageously be used as an acoustically effective damping element in a motor vehicle owing to their respective acoustic properties.

Such a damping element can in particular be an acoustically effective exterior or interior component.

Very particularly preferably, such a damping element is a bonnet insulator, an electric motor casing, a headliner insulator, a longitudinal member filling, a sill filling, an A/B/C pillar filling, a bulkhead insulator, a tunnel absorber, a door insulator or a wheel arch absorber.

### BRIEF DESCRIPTION OF THE DRAWINGS

The present disclosure is explained in detail below based on exemplary embodiments with reference to the appended figures. These exemplary embodiments are intended to make it easier for a person skilled in the art to implement the disclosure. They do not limit the scope of the disclosure. In the figures

FIG. 1: shows a first exemplary embodiment for an acoustically effective component according to the disclosure in a side sectional view.

FIG. 2 shows a first exemplary embodiment for an acoustically effective component 1 according to the disclosure in a side sectional view. It has a first plastic film 10, which is micro-perforated and has a specific flow resistance of 750 Rayl±50 Rayl.

### DETAILED DESCRIPTION OF THE DRAWINGS

A second plastic film 20, which is also micro-perforated, also has a specific flow resistance of 750 Rayl±50 Rayl.

Both plastic films 10, 20 consist of a double film, which comprises a thermoplastic layer made of PE, which can be thermally welded. Both films 10, 20 have a thickness of respectively 40 micrometres and their density is respectively around 1.0 g/cm³.

Furthermore, the plastic film is flame retardant according to the prior art.

The plastic films 10, 20 are connected to each other all round the edges by means of welding such that the plastic films 10, 20 together form a bag with a chamber 30.

The chamber 30 is filled with a filling 40, which consists of foam particles from an open-cell PUR foam. 50% by weight of the filling consists of viscoelastic foam particles and a further 50% by weight of the filling consists of non-viscoelastic foam particles.

Such a component has a particularly high acoustic absorption capacity at low frequencies of the human hearing spectrum.

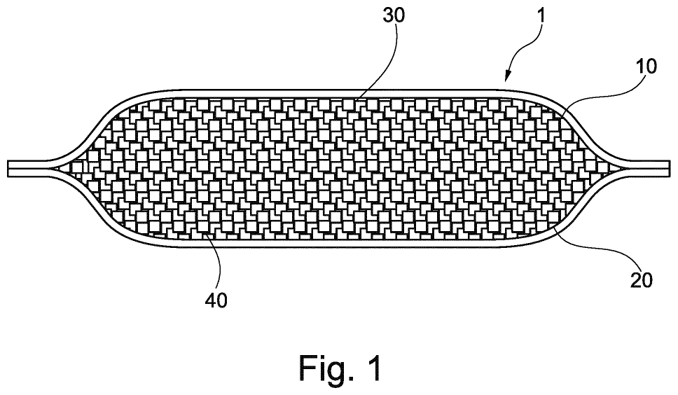

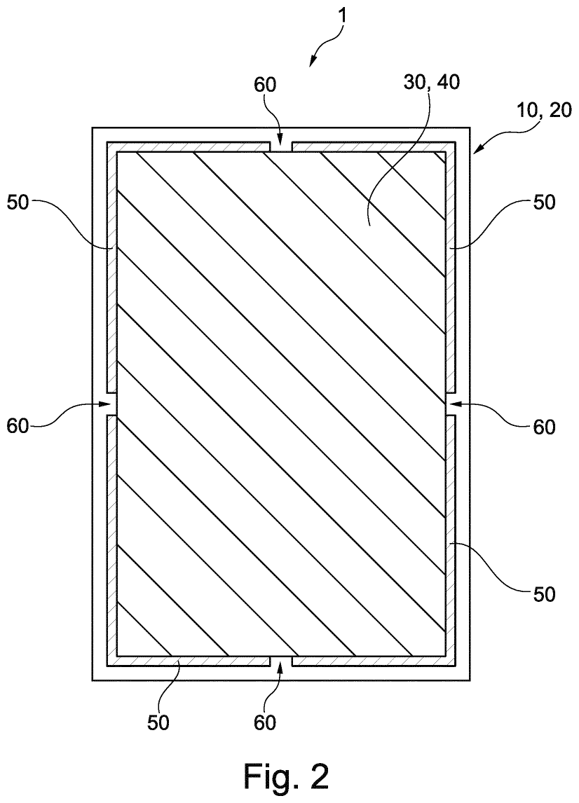

FIG. 2 shows another exemplary embodiment of a component 1 according to the disclosure in plan view, which corresponds to the exemplary embodiment according to FIG. 1 with the exception of the following differences:

Both plastic films 10, 20 are impermeable to media. As in the first exemplary embodiment, they are connected to each other all round the edges by means of welding such that the plastic films 10, 20 together form a bag with a chamber 30. FIG. 2 shows this weld as a weld line 50. Unlike the first exemplary embodiment, this weld line 50 is interrupted on each side of the component 1 shown in FIG. 2 approximately in the centre of the side edge. Each interruption 60 is around 1-2 millimetres long. Each interruption 60 constitutes an overflow valve for air that is trapped inside the bag. If an external force acts on the component 1, air can escape via these overflow valves, i.e. the component 1 is compressed. How quickly such a component 1 can be compressed when applying a defined external force is determined both by the number and by the dimensions of the individual interruptions 60.

As the two plastic films 10, 20 lie flat on top of one other, they are pressed together by the ambient pressure of the air, whereby the overflow valves offer increased flow resistance to the air that flows back into the component 1 when the compressed foam re-expands. For a given number of interruptions 60, suitable dimensioning of the individual interruptions 60 can be used to set how quickly a compressed component 1 re-expands. This ensures that the worker on the production line has sufficient time to properly place a compressed component 1 in a car body cavity, for example.

As the two plastic films 10, 20 lie flat on top of one other, the component is also highly impermeable, at least against splash water, such that such a component 1 can be used in the exterior of a vehicle body without any problems.

In another exemplary embodiment, an extended double film is provided, which comprises a thermoplastic layer made of PE such that the plastic film can be thermally welded, for instance.

The thickness of the plastic film is respectively around 40 micrometres and its density is respectively around 1.0 g/cm³.

Furthermore, the plastic film is flame retardant according to the prior art.

The plastic film is micro-perforated, wherein the characteristic dimensions of the micro-perforations are around 60 micrometres. The density of the micro-perforations is selected such that the plastic film has a specific flow resistance of 100 Rayl±20 Rayl.

The plastic film is moulded into a tube in sections, wherein the longitudinal seam is formed by thermally welding the plastic film.

The one end of the tube is also sealed be means of thermal welding, producing a bag.

Residues of an open-cell, non-viscoelastic polyether foam are mechanically shredded such that flakes with an average size of around 15 millimetres are obtained. The polyether foam has a density between 28 kg/m³ and 40 kg/m³.

Furthermore, residues of two open-cell, viscoelastic polyether foams are mechanically shredded such that flakes with an average size of around 15 millimetres are in turn obtained. The first viscoelastic polyether foam has a density between 40 kg/m³ and 50 kg/m³. The second viscoelastic polyether foam has a density of around 80 kg/m³.

The resulting foam flakes from both viscoelastic foams are mixed in a mechanical mixer in a weight ratio of 90% of the lower density foam and 10% of the higher density foam.

The resulting viscoelastic foam mixture is mixed in a mechanical mixer with the foam flakes from the non-viscoelastic foam in a weight ratio of 40% viscoelastic portion to 60% non-viscoelastic portion.

Individual portions are removed from the resulting foam flake mixture, the size of which is determined by the weight of the portions. The weight of a portion is calculated in such a way that the density of the filling in the volume of the ready-to-use bag is in the range of 24 kg/m³.

The individual portions are gravity-fed via a funnel as loose bulk into a film bag provided. For this purpose, the film bag is pulled over the spout of the funnel.

Finally, the filled bag is fed to a welding machine, which seals the bag at its still open end by means of thermal welding.

Such a component has a particularly high acoustic absorption capacity in the medium to higher frequency range of the human hearing spectrum.

If bags obtained in this way are compressed by 50% in terms of their volume relative to their force-free/relaxed configuration, their acoustic damping capacity is higher than that of a pure polyether foam above a cut-off frequency in the range of a few hundred Hertz.

Finally, in an alternative embodiment of the aforementioned exemplary embodiment, the plastic film is impermeable to media. All other features correspond to those of the aforementioned exemplary embodiment.

The typical dimensions of the components according to the aforementioned exemplary embodiments are around 10 cm to 150 cm in length and around 5 cm to 50 cm in width.

1. An acoustically effective component for a motor vehicle, the component comprising:
a) a bag formed from at least one plastic film and which forms a chamber, and
b) a filling, which is arranged in the chamber, wherein the filling has foam particles of open-cell and/or mixed-cell foams,
wherein
the filling has a mixture of foam particles, wherein the mixture
i) comprises a first portion of non-viscoelastic foam, and
ii) comprises a second portion of viscoelastic foam.

2. The component according to claim 1, wherein the foam particles have an average size of at least 5 millimetres.

3. The component according to claim 1, wherein the filling has an average density of 24 kg/m³±6 kg/m³.

4. The component according to claim 1, wherein the first portion accounts for a proportion by weight of at least 40% and up to 60% of the filling and the proportion by weight of the second portion accounts for at most 60% and at least 40%.

5. The component according to claim 1, wherein the foam of the first portion of the filling has an average density of 28-40 kg/m³.

6. The component according to claim 1, wherein the foam of the second portion of the filling has an average density of 40-50 kg/m³.

7. The component according to claim 1, wherein the foam particles of the first and/or second portion comprise PUR.

8. The component according to claim 1, wherein the second portion of the foam particles comprises for its part two fractions, which differ in their density by at least 25%.

9. The component according to claim 8, wherein the first fraction of the viscoelastic portion has an average density of 40 kg/m³-50 kg/m³ and the second fraction has an average density of 70 kg/m³-90 kg/m³.

10. The component according to claim 8, wherein the proportion by weight of the first fraction is between 80% and 100% and the proportion by weight of the second fraction is between 20% and 0%.

11. The component according to claim 1, wherein the plastic film has one or more of the following features:
a) the plastic film is impermeable to media or micro-perforated, wherein
i) the characteristic dimensions of the micro-perforations are smaller than 100 micrometres,
ii) the micro-perforated plastic film has a specific flow resistance between 10 and 1,500 Rayl,
b) the plastic film has a thermoplastic material or is made of such a material,
c) the thickness of the plastic film is between 30 and 100 micrometres,
d) the density of the plastic film is between 0.8 and 1.2 g/cm³,
e) the plastic film has at least two layers,
f) the plastic film can be welded, for example thermally, by means of ultrasound or by means of friction welding, and
g) the plastic film is flame retardant.

12. The component (1) according to claim 1, wherein the plastic film is pressed, glued or welded to itself to form the bag.

13. The component according to claim 1, wherein the chamber has a chamber volume and the non-compressed volume of the filling is around 50%±15% of the chamber volume.

14. The component according to claim 1, wherein the component is an exterior or interior component for a motor vehicle.

15. The component according to claim 14, wherein the component is a longitudinal member filling, a sill filling, an A/B/C pillar filling, a bulkhead insulator, a tunnel absorber, a door insulator or a wheel arch absorber.

16. A method for producing an acoustically effective component, the method including the following steps:
a) providing a bag formed from at least one plastic film and which forms a chamber,
b) providing a filling, which has foam particles of open-cell and/or mixed-cell foams, wherein the filling has a mixture of foam particles, wherein the mixture
i) comprises a first portion of non-viscoelastic foam, and
ii) comprises a second portion of viscoelastic foam, and
c) inserting the filling into the bag.

17. The method according to claim 16, wherein the filling is divided into portions of defined weight before being inserted into the chamber.

18. (canceled)

19. The method according to claim 16, wherein the bag is sealed once the filling has been inserted.

20. (canceled)

21. A method for the intended use of a component according to the invention in a motor vehicle, wherein the bag is compressed relative to its rest position before it is arranged at its intended place of use in the motor vehicle.

22. The method according to claim 21, wherein the component is arranged at its intended place of use in the motor vehicle such that the volume of the component arranged in the motor vehicle is reduced by at least 30% relative to its volume in its uncompressed rest position.
